(19) United States
(12) Patent Application Publication
(10) Pub. No.: US 2026/0048432 A1
(43) Pub. Date: Feb. 19, 2026

(54) PRESS WITH GUARD FOR IRREGULAR DIE SHAPES

(71) Applicant: Government of the United States as represented by the Secretary of the Air Force, Wright-Patterson AFB, OH (US)

(72) Inventor: Loc Lam, Moore, OK (US)

(21) Appl. No.: 18/805,655

(22) Filed: Aug. 15, 2024

(51) Int. Cl. B21D 55/00; F16P 3/04

(52) U.S. Cl. CPC B21D 55/00; F16P 3/04

(57) ABSTRACT

A stamping press having upper and lower dies to deform a sheet of material. The press has an irregularly shaped opening with greater and lesser height across the width of the press. The press has a guard to prevent inadvertent insertion of extremities between the dies when feeding a sheet for stamping. The guard is also irregular in that it may be skewed to preferentially cover greater parts of the opening and/or may have an irregularly shaped lower edge which can be registered with a like or similar edge of the lower die.

### FIELD OF THE INVENTION

The present invention is related to stamping presses having guards to protect the hands of an operator and more particularly to such a presses having a guard for irregular die spaces.

### STATEMENT OF GOVERNMENT INTEREST

The invention described and claimed herein may be manufactured, licensed and used by and for the Government of the United States of America for all government purposes without the payment of any royalty.

### BACKGROUND OF THE INVENTION

Stamped sheet metal and thermoformed plastic sheets are ubiquitous. Stamped sheet metal ranges from small tabs to large truck panels. Thermoformed plastic sheets range from single serving coffee creamers to shelves for refrigerator doors. All of these parts have deformations out of the plane of the sheet.

The sheets are bent, stamped or otherwise formed by a press, with optional heat. The press has two heads, with at least one head moving in relation to the other. Typically a lower head is fixed and an upper head vertically cycles between in an opening and closing direction between opposed open and closed positions. Each head may be fitted with one or more removably attachable dies to manufacture the particular workpiece under consideration. The dies on the upper head and lower head are complementary to deform the upper and lower faces of the sheet, respectively. The dies have a width which may accommodate a large number of smaller workpieces in the sheet or fewer, even one, larger workpiece in the sheet.

When the moving head cycles to the open position, typically in an upwards position, a die space is formed between the upper die and the lower die. A green sheet may be inserted into the die space, then the press cycled to move the movable die(s) to a closed position, typically vertically downward. The green sheet is then plastically deformed between the dies and the process repeated. The heads reopened and the plastically deformed sheet removed. The process is repeated as many times as necessary to complete production. A green sheet may be flat or may have undergone a previous operation.

Stamping presses have been used for these operations for more than 200 years. And serious injuries to operators have occurred for more than 200 years. For example, while the press heads are in the open position, an operator inserts or removes the sheet. If the press cycles, serious injury and even amputation may result. Despite OSHA regulations, e.g. 29 CFR 1910.217, the Bureau of Labor Statistics estimates at least 2000 amputations occur annually due to press accidents, with even more additional injuries.

Various safety devices have been attempted in the art to mitigate and prevent such accidents. For example, one attempt uses a pivoting guard which the operator rotates into place before cycling the press. However, if the operator neglects to move the guard into place or the guard freezes in the open position, injuries can still occur. Yet other attempts automatically cycle the guard with a dedicated mechanism. However, such a mechanism is prone to breakage and requires regular maintenance. And such guards require changeout and/or adjustment when different dies are inserted in the heads. If the wrong guards are used, then safety is further compromised.

Yet other attempts rely upon switches in series which must be simultaneously depressed to activate the press. But these switches and extra electrical features are prone to breakage and misuse. Yet other approaches rely upon hydraulics which are prone to leakage. Clearly another approach is needed.

A guard is needed which is not required to be powered or to move independent of the press cycles. Such a guard is preferably able to accommodate complex dies which have differential die spaces across the width of the die. Finally, such a guard should be adjustable to accommodate different dies without removal from the head of the press.

### SUMMARY OF THE INVENTION

In one embodiment the invention comprises a press for deforming sheet materials. The press comprises: first and second complementary heads for receiving corresponding first and second dies therein, the first and second heads defining a width direction and a feed direction perpendicular thereto; at least one of the heads being movable relative to the other in an opening and closing direction, each of the first die and second die having a respective first and second front edge facing towards an operator, and defining an irregular space therebetween when the heads are in an open position, the irregular space being greater at a first position along the width and lesser at a second position along the width; and a generally rectangular static guard disposed on one the first heads and having alternatingly longer and shorter sides defining a major axis parallel to the longer sides, the major axis being skewed relative to the width direction, whereby the guard is sized to inhibit passing of a hand therepast when the first and second heads are in the open position and allows the sheet material to be worked when the first and second heads are in the closed position. As used herein the hand is inclusive of all upper extremities, including fingers and arms as well.

In one embodiment the invention comprises a method of plastically deforming a sheet. The method comprises the steps of: providing a press having a fixed lower head a lower die and movable upper head having an upper die complementary to the lower die, each of the lower die and the upper die having a respective and horizontal upper die width and lower die width, the lower die and the upper die having a die space therebetween when the lower head and the upper head are separated, the die space having a substantially horizontal major axis and a differential height throughout the die space; providing a static guard on the upper head of the press and being movable relative thereto independent of movement of the upper die, the guard having a lower edge which is rectilinear and skewed relative to the horizontal; and positioning the guard on the upper head to define a first feed space which allows a sheet material therepast while substantially inhibiting an operator's 20 hand from passing below the guard so that the guard.

This method may optionally comprise the steps of: replacing at least one of the first lower die with a second lower die or replacing the first upper die with a second upper die; repositioning the guard on the upper head to define a second feed space which allows a sheet material therepast while substantially inhibiting an operator's hand from passing below the guard so that the guard; inserting a second sheet of material into the die space in the forward feed direction; cycling the press to plastically deform the second sheet of material between the upper die and lower die into a second deformed configuration; and removing the deformed second sheet of material from the die space.

In one embodiment the method comprises plastically deforming a sheet. The method comprises the steps of: providing a press having a fixed lower head a lower die and movable upper head having an upper die complementary to the lower die, each of the lower die and the upper die having a respective and horizontal upper die width and lower die width, the lower die and the upper die having a first irregular die space therebetween when the lower head and the upper head are separated, the die space having a substantially horizontal major axis and a differential height throughout the first die space; providing a static guard on the upper head of the press and being movable relative thereto independent of movement of the upper die, the guard having an irregular lower edge; and positioning the guard on the upper head to register the irregular lower edge with the irregular die spaced define a first feed space between the lower die and the upper die and which allows a sheet material therepast while substantially inhibiting an operator's hand from passing below the guard so that the guard.

### BRIEF DESCRIPTION OF THE DRAWINGS

FIG. 1 is a schematic perspective view of a press with a guard according to the present invention.

FIG. 2 is a schematic frontal view of opposed press dies with a guard according to the present invention.

FIG. 3 is a schematic frontal view of an alternative embodiment of opposed press dies with a guard according to the present invention shown in phantom with the guard and dies shown to scale.

FIG. 4 is a frontal view of opposed press dies with a guard according to the present invention, with the guard and dies being shown to scale.

FIG. 5 is a schematic side elevational view of opposed heads, respective dies and an operator with a sheet shown in phantom.

### DETAILED DESCRIPTION OF THE INVENTION

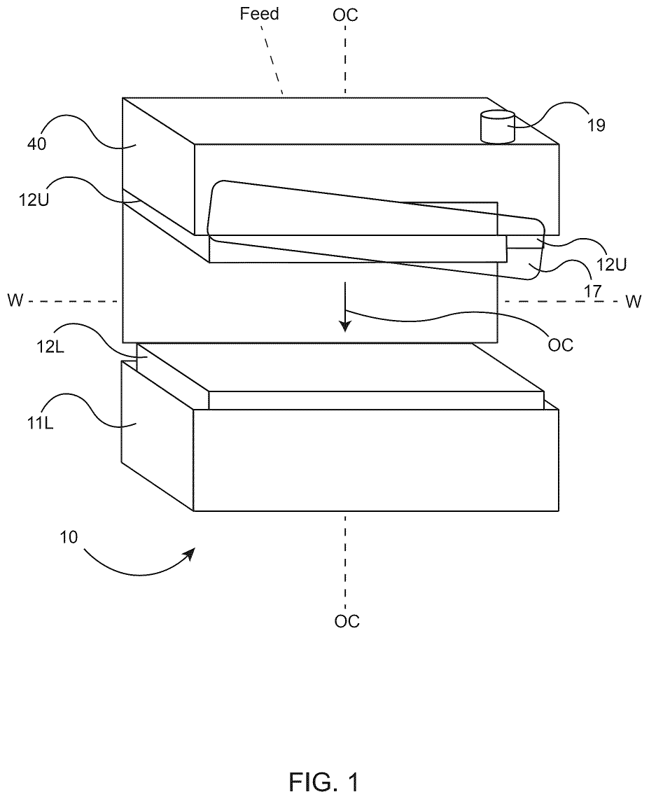

Referring to FIG. 1, the invention comprises a press 10. The press 10 has at least two opposed heads connected by a stationary frame. The heads are configured for relative motion therebetween. Typically a lower head 11L is stationary, and an upper head 11U reciprocates relative thereto in an opening and closing direction OC. The opening and closing direction OC may be vertical or substantially vertical. A cycle of the press 10 is reciprocation of the upper head 11U and/or lower head 11L relative to the other from an open position to a closed position and back to the open position. The open position is the maximum spacing between the upper had and lower head 11L in an opening and closing position as taken in the opening and closing direction OC. The closed position is the minimum spacing between the upper had and lower head 11L in an opening and closing position as taken in the opening and closing direction OC. As described hereinbelow, the press 10 and its operation will have a stationary lower head 11L and vertically reciprocating upper head 11U, although the invention is not so limited.

The upper head 11U and lower head 11L have an upper die 12U and lower die 12L, respectively, removably installed therein. The press 10 cycles in the opening and closing direction OC from an open position with the upper head 11U raised, to a closed position where the upper head 11U is brought towards and proximate the lower head 11L. The upper die 12U and lower die 12L are complementary, plastically deforming a workpiece therebetween when proximated during the closing process. The sheet 30 may be subjected to multiple stamping operations to yield the desired finished workpiece. That is the workpiece may be stamped from an initial flat, generally planar configuration to a first, deformed configuration, then restamped as many times as necessary to achieve the final configuration.

The upper die 12U and lower die 12L have a width W which likewise accommodate the width W of the intended workpiece. The width W is typically, but not necessarily, perpendicular to the opening closing direction. A feed direction FD is mutually perpendicular to the opening and closing direction OC and the width W direction. The workpiece is inserted into the press 10, between the upper die 12U and the lower die 12L in the feed direction FD and particular in a forward feed direction FD. Upon stamping, the upper is head and the workpiece can be withdrawn opposite the forward feed direction FD or continue out the back of the press 10 in the forward feed direction FD.

The upper die 12U and lower die 12L have a space 14 therebetween in the closed position. If the opening and closing direction OC is vertical, the space 14 between the upper die 12U and lower die 12L may be referred to as a height. The space 14 accommodates the thickness of the sheet 30 and the desired deformation out of the plane of the sheet 30. Across the width W of the upper die 12U and lower die 12L is a differential spacing. By differential spacing it is meant that at one position of the width W there is a first distance or space 14 between the upper die 12U and lower die 12L, as measured in the opening and closing direction OC. At another position of the width W there is a second distance or space 14 between the upper die 12U and lower die 12L, as measured in the opening and closing direction OC. The second spacing is unequal to and greater than the first spacing. There may also be differential spacing in the feed direction FD. However, only differential spacing across the front faces of the upper ide and lower die 12L, as faces towards an operator 20 is considered for the invention. A space 14 between an upper die 12U and lower die 12L having different dimensions in the opening and closing direction OC at different locations across the width W is referred to herein as an irregular space 14.

The press 10 also comprises a guard 17. The guard 17 is generally planar and fits against the upper head 11U or lower head 11L, facing towards the operator 20. The guard 17 is generally planar and has a major axis MA which is parallel to, or acutely oblique to, the width W direction.

The guard 17 is preferably transparent, so that the operator 20 can view the stamping process for safety. The guard 17 may be a synthetic polymer of methyl methacrylate, such as acrylic, typically plexiglass, polycarbonate or PETG. The guard 17 may have a thickness of 4 mm to 14 mm and preferably about 6 mm to 12 mm. The guard 17 prevents a user from inserting his/her hand 21 between the dies for safety. The guard 17 also prevents shrapnel or other missile hazards from being propelled to the operator 20. In a less preferred embodiment, the guard 17 may have a frame supporting a taut net.

The workpiece is typically, but not limited to, a plastically deformable, macroscopically monoplanar sheet 30. The sheet 30 is deformed out of its plane by compressive forces between the upper die 12U and the lower die 12L during the stamping process.

The press 10 may have a controller 19 which directs operation of the press. The controller 19 may manage cycle time, stroke length, hydraulic pressure, electrical current, compressive force, etc. through a microcontroller or other control systems. The frame, controller 19 and ancillary features of the press 10 form no part of the claimed invention, except as may be specifically claimed below. The press 10 may be made and operated according to 4039060 to Williams et al., 4147492 to Thiel et al., 9676021 to Lozano Bonet, 10369613 to Xu et al., 11453039 to Kneer and US 2018/0029104 to Hafner, the disclosures of which are incorporated herein by reference.

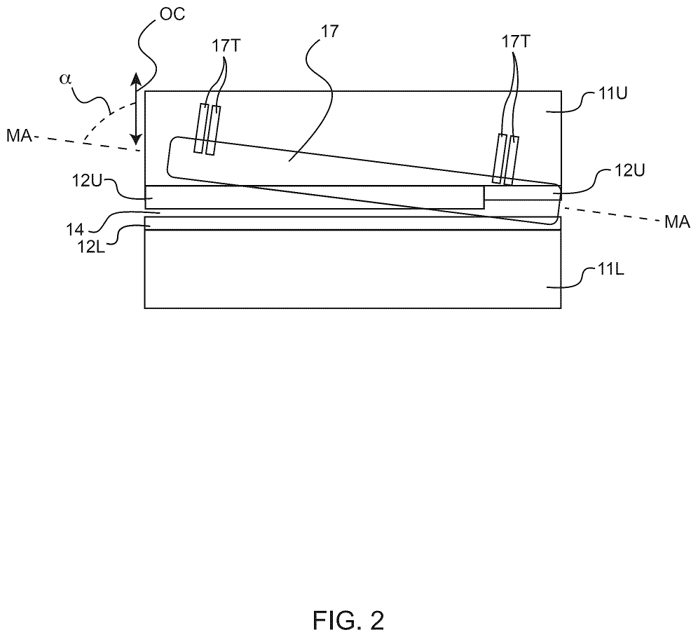

Referring to FIG. 2, and examining the invention in more detail, the guard 17 of the present invention is a static guard 17. By static it is meant that the guard 17 is not powered and does not require action by the operator 20, controller 19 or otherwise, beyond ordinary and routine cycling of the press.

The guard 17 may be generally rectangular. This shape provides the benefit of ease of manufacture and conservation of material. The guard 17 may be mounted on the upper head 11U for convenience and convention, although the invention is not so limited. The guard 17 may be movably disposed on the head, so that it can be adjusted in the opening and closing direction OC. As the guard 17 is adjusted upwards, more space 14 between the upper die 12U and lower die 12L is revealed. This position allows more space 14 for insertion of the sheet 30 in the feed direction FD, but also provides more opportunity for the operator 20 to insert his/her past the guard 17 towards the upper die 12U and lower die 12L. If the space 14 between the upper die 12U and lower die 12L is sufficient, the operator 20 could pass the guard 17 and insert his/her hand 21 between the upper die 12U and lower die 12L. As the guard 17 is adjusted downward, more protection is afforded for the operator 20's hands 21, but access and for the sheet 30 is impaired. A guard 17 according to the prior art is inadequate.

However, if the guard 17 is, aligned relative to the width W direction/opening and closing direction OC so that the major axis MA of the guard 17 is skewed relative to the width W direction, a convenient, rectangular, static guard 17 can provide enhanced protection for a press 10 having an irregular space 14 between the upper die 12U and lower die 12L. The major axis MA of the guard may form an included angle a with the opening and closing direction OC of 70 degrees to 85 degrees and preferably 75 degrees to 85 degrees. A greater included angle a brings the guard 17 into closer alignment with the horizonal and does not protect against irregular spaces 14. A lesser included angle a brings may uncover excessive irregular space 14, minimizing protection. The guard may translate from 4 cm to 25 cm in the in the opening and closing direction OC.

More particularly, the guard 17 may be skewed so that it covers more of the space 14 between the upper die 12U and lower die 12L, at the width W position where the upper die 12U and lower die 12L are further apart. For example, as shown, if the right side of the dies 12U, 12L are spaced further apart than the left side of the dies 12U, 12L, the guard 17 may be angled downwardly to the right to increase coverage of the irregular space 14. A guard 17 mounted on the upper head 11U has a lower edge which determines the spacing for sheet 30 feed.

Furthermore, the guard 17 may be movably disposed on the respective head 11U, 11L. The guard 17 may translate up and down, or more generally in the opening and closing direction OC to reveal or obturate the space 14 as needed. The guard 17 may be movably supported on tracks 17T. The tracks 17T may be parallel to the opening and closing direction OC.

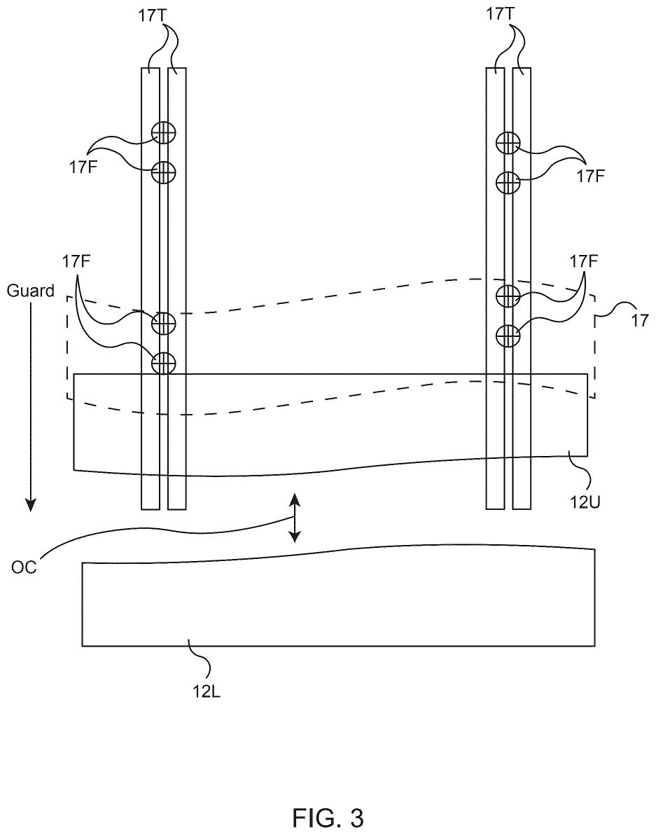

Referring to FIG. 3, in another embodiment a different irregular space 14 is shown. This irregular space 14 has equal spacing between the upper die 12U and lower die 12L across the width W. However, the position of the space 14 in the opening and closing direction OC varies across the width W. This irregular space 14 can be safely accommodated with a static guard 17 which is generally matched to and registered with such irregular space 14. This arrangement provides the benefit that a lower die 12L which does not have a flat face can be accommodated and protected.

Again, the guard 17 may be mounted on tracks 17T to raise and lower/reveal and obturate more or less space 14 for sheet 30 feed, respectively. The tracks 17T may be fixedly mounted or adjustably mounted to the upper head 11U, or lower head 11L, as desired with fasteners 17F. Likewise, the tracks 17T may be fixedly mounted or adjustably mounted to the guard 17 with fasteners 17F.

Again, lowering the guard 17 to partially block the opening where the sheet 30 is inserted between the upper die 12U and lower die 12L protects hands 21 from insertion between the upper head 11U and lower head 11L despite the irregular space 14 therebetween. Again, the sheet 30 may be inserted in the sheet 30 feed direction FD between the upper die 12U and lower die 12L with the guard 17 in a protective position. This embodiment provides the benefit that a non-planar sheet 30 may be accommodated. For example, if the sheet 30 is subjected to plural stamping operations, the sheet 30 will likely be non-planar after the first, second, third stamping operation, etc. But the non-planar sheet 30 can still be safely subjected to subsequent stamping with a press 10 having an irregular space 14 between the dies 12U, 12L.

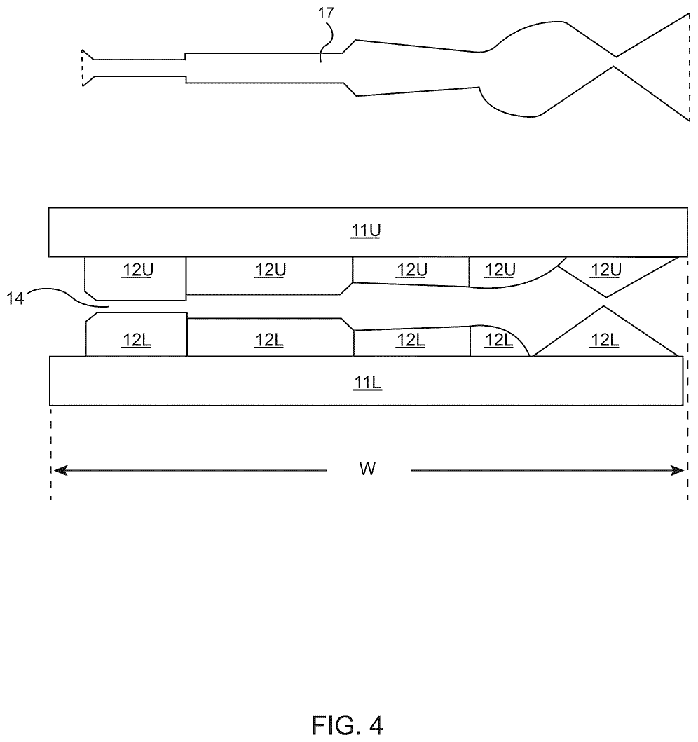

Referring to FIG. 4, in another embodiment, the guard 17 may have an irregular shape generally matched to or congruent with the irregular shape of the space 14 between the upper die 12U and lower die 12L. Particularly, the lower edge of the guard 17 has an irregular shape matched to or congruent with the irregular lower die 12L. This embodiment provides the benefit that the guard 17 may be lowered to various levels of coverage for different planar or non-planar sheets 30. For example, a sheet 20 may be stamped in a first press 10 to a first configuration which is only slightly non-planar, i.e. the maximum deformation out of plane is 1 cm. A second stamping operation at a second press 10 may increase the maximum deformation to 2 cm and so forth. The guard 17 of this embodiment may be successively lowered for each stamping operation. The same guard 17 may be used for any number of presses, increasing standardization and decreasing cost.

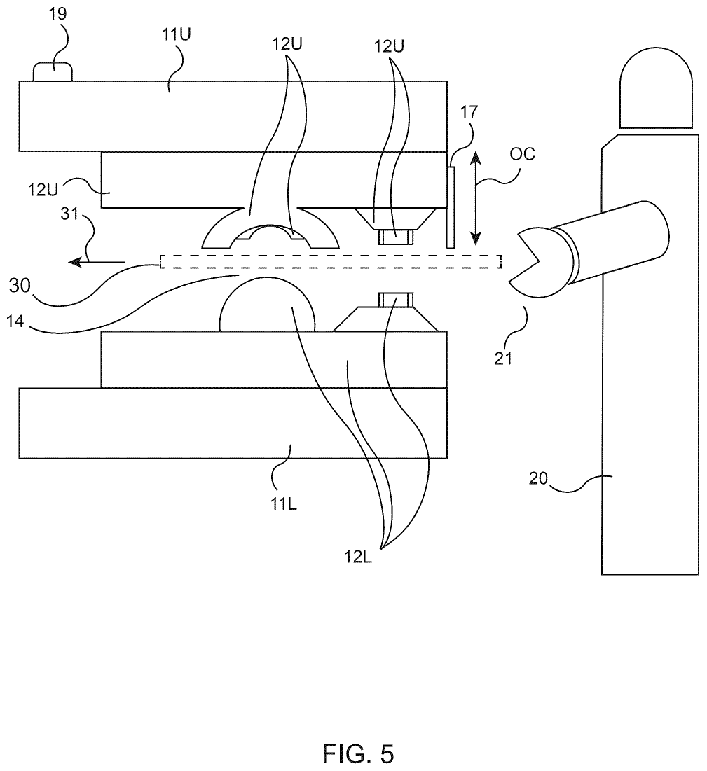

Referring to FIG. 5, in operation an operator 20 is provided with a sheet 30. The operator 20 holds the sheet 30 with the plane thereof parallel to the major axis MA of an irregular space 14 between an upper die 12U and lower die 12L. The upper die 12U and lower die 12L are separated, with the upper die 12U being raised to an open position. The guard 17 may be rectangular for simplicity of manufacture, may have an irregular edge for matching to the upper die 12U or more likely lower die 12L. The user inserts the sheet 30 past the guard 17 without his/her hands 21 going past the guard 17 due to the guard 17 inhibiting admission of the hands to the irregular space 14 between the dies 12U, 12L.

If desired, the press 10 may have two or more guards 17 across the width W. Plural guards 17 provide the benefit that each guard can be tailored to the specific space 14 being protected.

All values disclosed herein are not strictly limited to the exact numerical values recited. Unless otherwise specified, each such dimension is intended to mean both the recited value and a functionally equivalent range surrounding that value. For example, a dimension disclosed as “40 mm” is intended to mean “about 40 mm.” The term “or” as used herein is to be interpreted as an inclusive or meaning any one or any combination. Therefore, “A, B or C” means “any of the following: A; B; C; A and B; A and C; B and C; A, B and C.” Every document cited herein, including any cross referenced or related patent or application, is hereby incorporated herein by reference in its entirety unless expressly excluded or otherwise limited. The citation of any document or commercially available component is not an admission that such document or component is prior art with respect to any invention disclosed or claimed herein or that alone, or in any combination with any other document or component, teaches, suggests or discloses any such invention. Further, to the extent that any meaning or definition of a term in this document conflicts with any meaning or definition of the same term in a document incorporated by reference, the meaning or definition assigned to that term in this document shall govern according to Phillips v. AWH Corp., 415 F.3d 1303 (Fed. Cir. 2005). All limits shown herein as defining a range may be used with any other limit defining a range of that same parameter. That is the upper limit of one range may be used with the lower limit of another range for the same parameter, and vice versa. As used herein, when two components are joined or connected the components may be interchangeably contiguously joined together or connected with an intervening element therebetween. A component joined to the distal end of another component may be juxtaposed with or joined at the distal end thereof. While particular embodiments of the present invention have been illustrated and described, it would be obvious to those skilled in the art that various other changes and modifications can be made without departing from the spirit and scope of the invention and that various embodiments described herein may be used in any combination or combinations. It is therefore intended the appended claims cover all such changes and modifications that are within the scope of this invention.

What claimed is:

1. A press for deforming sheet materials and comprising:
first and second complementary heads for receiving corresponding first and second dies therein, the first and second heads defining a width direction and a feed direction perpendicular thereto;
at least one of the heads being movable relative to the other in an opening and closing direction, each of the first die and second die having a respective first and second front edge facing towards an operator, and defining an irregular space therebetween when the heads are in an open position,
the irregular space being greater at a first position along the width and lesser at a second position along the width; and
a generally rectangular static guard disposed on one the first heads and having alternatingly longer and shorter sides defining a major axis parallel to the longer sides, the major axis being skewed relative to the width direction, whereby the guard is sized to inhibit passing of a hand therepast when the first and second heads are in the open position and allows the sheet material to be worked when the first and second heads are in the closed position.

2. A press according to claim 1 wherein the first head is disposed above the second head and the guard is movably disposed on the first head.

3. A press according to claim 2 wherein the major axis of the guard defines an included angle with the opening and closing direction of 75 degrees to 85 degrees.

4. A press according to claim 3 wherein the opening and closing direction is vertical.

5. A press according to claim 3 wherein the guard translates from 4 cm to 10 cm in the in the opening and closing direction OC.

6. A method of plastically deforming a sheet comprising the steps of:
providing a press having a fixed lower head a lower die and movable upper head having an upper die complementary to the lower die, each of the lower die and the upper die having a respective and horizontal upper die width and lower die width, the lower die and the upper die having a die space therebetween when the lower head and the upper head are separated, the die space having a substantially horizontal major axis and a differential height throughout the die space;
providing a static guard on the upper head of the press and being movable relative thereto independent of movement of the upper die, the guard having a lower edge which is rectilinear and skewed relative to the horizontal; and
positioning the guard on the upper head to define a first feed space which allows a sheet material therepast while substantially inhibiting an operator's hand from passing below the guard so that the guard.

7. A method according to claim 6 wherein the step of positioning the guard comprises the step of adjusting the guard in a direction substantially perpendicular to the lower edge thereof.

8. A method according to claim 6 wherein the step of positioning the guard comprises the step of adjusting the guard in a vertical direction.

9. A method according to claim 6 wherein the step of positioning the guard on the upper head comprises positioning the guard on a plurality of tracks fixedly joined to the upper head and being adjustable along the length of the plural tracks to increase access to or to obstruct access to the die space.

10. A method according to claim 6 further comprising, in order, the steps of:
inserting a first sheet of material into the die space in a forward feed direction;
cycling the press to plastically deform the sheet of material between the upper die and lower die into a first deformed configuration; and
removing the deformed first sheet of material from the die space.

11. A method according to claim 10 wherein the lower die is a first lower die and the upper die is a first upper die, and further comprising the steps of:
replacing at least one of the first lower die with a second lower die or replacing the first upper die with a second upper die;
repositioning the guard on the upper head to define a second feed space which allows a sheet material therepast while substantially inhibiting an operator's hand from passing below the guard so that the guard;
inserting a second sheet of material into the die space in the forward feed direction;
cycling the press to plastically deform the second sheet of material between the upper die and lower die into a second deformed configuration; and
removing the deformed second sheet of material from the die space.

12. A method according to claim 11 wherein the step of replacing at least one of the first lower die with a second lower die or replacing the first upper die with a second upper die comprises replacing both of the first lower die with a second lower die and replacing the first upper die with a second upper die.

13. A method according to claim 11 wherein the step of repositioning the guard comprises the step of:
moving the guard towards or away from the guard space in a direction having a vector component in the vertical direction.

14. A method according to claim 11 wherein the guard has a first skew relative to the horizontal, and the step of repositioning the guard comprises the step of:
articulating the guard to convert the first skew to a second skew unequal to the first skew.

15. A method of plastically deforming a sheet comprising the steps of:
providing a press having a fixed lower head a lower die and movable upper head having an upper die complementary to the lower die, each of the lower die and the upper die having a respective and horizontal upper die width and lower die width, the lower die and the upper die having a first irregular die space therebetween when the lower head and the upper head are separated, the die space having a substantially horizontal major axis and a differential height throughout the first die space;
providing a static guard on the upper head of the press and being movable relative thereto independent of movement of the upper die, the guard having an irregular lower edge; and
positioning the guard on the upper head to register the irregular lower edge with the irregular die spaced define a first feed space between the lower die and the upper die and which allows a sheet material therepast while substantially inhibiting an operator's hand from passing below the guard so that the guard.

16. A method according to claim 15 wherein the step of registering the irregular lower edge of the guard comprises the steps of:
determining the maximum opening of the die space in the vertical direction and the width thereof;
providing a static guard having a depending panel which matches ______% to ______% of the maximum die space when installed on the upper head.

17. A method according to claim 16 herein the step of positioning the guard on the upper head comprises positioning the guard on a plurality of tracks fixedly joined to the upper head and being adjustable along the length of the plural tracks to increase access to or to obstruct access to the die space.

18. A method according to claim 17 wherein the plural tracks are mutually parallel.

19. A method according to claim 17 wherein the plural tracks are not mutually parallel.

20. A method according to 19 wherein the lower die is a first lower die and the upper die is a first upper die, and further comprising the steps of:
replacing at least one of the first lower die with a second lower die or replacing the first upper die with a second upper die;
to define a second irregular die space different than the first irregular die space when the lower head and the upper head are separated, the second die space having a substantially horizontal major axis and a differential height throughout the first die space; and
registering the guard with the second irregular die space without removing the guard from the head.
